(19) United States
(12) Patent Application Publication
(10) Pub. No.: US 2019/0107765 A1
(43) Pub. Date: Apr. 11, 2019

(54) HYBRID REFLECTIVE-EMISSIVE IMAGE DISPLAY

(71) Applicant: CLEARink Displays, Inc., Fremont, CA (US)

(72) Inventors: Lorne Whitehead, Vancouver (CA); Robert J. Fleming, San Jose, CA (US)

(73) Assignee: CLEARink Displays Inc., Fremont, CA (US)

(21) Appl. No.: 16/085,688

(22) PCT Filed: May 23, 2017
(86) PCT No.: PCT/US17/33904

§ 371 Date: Nov. 28, 2018

Related U.S. Application Data
(60) Provisional application No. 62/340,399, filed on May 23, 2016.

(51) Int. Cl. G02F 1/1677; G02B 26/00; G02F 1/167; G02F 1/1685; G09G 3/34; G09G 3/20

(52) U.S. Cl. CPC G02F 1/1677; G02B 26/005; G02F 1/167; G02F 1/1685; G02F 1/1679; G09G 3/2003; G09G 3/3406; G02F 2203/023; G02F 2203/026; G09G 3/344

(57) ABSTRACT

Reflective image displays use minimal power but have limited use in low ambient conditions. Emissive image displays are intrinsically reflective and must use significantly more power in high ambient light conditions to optimize the image quality which greatly limits the battery life. To date no single display technology has been able to provide excellent image quality in all ambient lighting conditions. The embodiments described herein involves the efficient hybridization of controlled reflection with controlled efficient emission to improve both the practicality and the overall performance of the display.

The instant specification claims priority to the U.S. Provisional Application Ser. No. 62/340,399 filed May 23, 2016, the specification of which is incorporated herein in its entirety.

### FIELD

The disclosed embodiments generally relate to electronically addressable image displays. In one embodiment, the disclosure relates to a hybrid image display comprising electronically addressable reflective and emissive components.

### BACKGROUND

In conventional electronic displays there have been two basic methods for producing an image. In each method, the image comprises small regions known as sub-pixels. Sub-pixels are ideally invisibly small under normal viewing conditions, often produce primary colors, and are arranged in small groups to form full color pixels.

The first conventional electronic display category are light-emitting displays. The source of visual information in the sub-pixels is a controllable light emitter that may take the form of a variable output inorganic or organic light emitting diode (LED). The source of visual information may also be a controlled-transmittance light shutter and color filter array that is backlit by a light source with a more constant output. In either case, additive mixing of the primary color sub-pixels produces the desired color image.

The second conventional display category are reflective displays. In this category the illuminated image arises from the ambient environment. The color of each sub-pixel may be determined by a color filter array. The brightness may be adjusted by controlling the reflectance of light from each sub-pixel, often by means of electrophoretic movement of light-absorbing particles. The reflectance mechanism may include reflective surfaces and/or reflective particles and/or total internal reflection (TIR) at optical interfaces that are shaped in advantageous ways.

While both of the basic conventional methods of producing electronic images may work well under many circumstances, they each contain fundamental, and different, limitations. In the case of light emitting displays, there are two basic challenges. First, the light emitting displays require electricity to produce emitted light. The needed electricity can cause shortcomings. This is especially true for portable display devices in bright ambient environments where the power requirement significantly reduces battery life. This may result in high energy consumption and operational costs for outdoor signage applications.

Second, light emitting displays are intrinsically quite reflective. Therefore, in the regions of a display that are intended to appear black, the controller can only stop light emission, not reflection. As a result, the surface may not appear black because of this intrinsic reflection of ambient light. Often this problem is ameliorated by means of light absorbing mechanisms that reduce the reflectance of ambient light. Unfortunately, this also reduces the efficiency of the emission of light from the display.

In the case of reflective image displays, there are two different problems. First, electronic reflective displays are not optimally reflective. In their brightest state, they fail to appear as white as white paper which users may find unappealing (this may not be too concerning under bright outdoor lighting conditions, but in normal indoor lighting it is a concern). Second, they may not be readable in the dark and in the absence of ambient light. This problem is true with conventional images printed on paper as well, but for an electronic display, customers expect a display useable in the dark.

The limitations are common to conventional displays and have not been overcome simultaneously. For this reason some applications have typically been satisfied with emissive displays, while others have used reflective displays. However, to date, no single display technology has been able to provide excellent image quality in all circumstances. The disclosed embodiments overcome these shortcoming.

### BRIEF DESCRIPTION OF DRAWINGS

These and other embodiments of the disclosure will be discussed with reference to the following exemplary and non-limiting illustrations, in which like elements are numbered similarly, and where:

FIG. 1A schematically illustrates a cross-section of a hybrid reflective-emissive image display according to one embodiment of the disclosure;

FIG. 1B schematically illustrates a top view of a hybrid reflective-emissive image display according to one embodiment of the disclosure;

FIG. 2A schematically illustrates a cross-section of a pixel of a hybrid reflective-emissive image display reflecting ambient light according to one embodiment of the disclosure;

FIG. 2B schematically illustrates a cross-section of a pixel of a hybrid reflective-emissive image display emitting green light according to one embodiment of the disclosure;

FIG. 3 schematically illustrates and an overhead view of a portion of a hybrid reflective-emissive display according to one embodiment of the disclosure;

FIG. 4 schematically illustrates an exemplary system for implementing an embodiment of the disclosure;

FIG. 5A illustrates the range of display illuminance, as a function of the ambient illuminance that is required for an image display to show bright, saturated color images;

FIG. 5B illustrates how reflective displays do not achieve the desired performance range as illustrated in FIG. 5A;

FIG. 5C illustrates the performance of conventional emissive displays in ambient lighting; and

FIG. 5D illustrates the performance of an embodiment of a reflective-emissive display described herein.

### DETAILED DESCRIPTION

Throughout the following description specific details are set forth in order to provide a more thorough understanding to persons skilled in the art. However, well-known elements may not have been shown or described in detail to avoid unnecessarily obscuring the disclosure. Accordingly, the description and drawings are to be regarded in an illustrative, rather than a restrictive or exclusive, sense.

In one embodiment, an exemplary display provides an efficient hybridization of controlled reflection with controlled efficient emission. The hybridization technique described herein may be highly synergistic in the sense that key features of the reflective display elements overlap synergistically with the key features of the light emitting display elements. This may greatly improve both the practicality and the overall performance of the display.

As stated, the disclosed embodiments generally relate to hybrid reflective and emissive image displays. According to certain embodiments, combining a reflective display with an emissive display may lead to a reduced power consumption hybrid display capable of single color, black and white or full color and high resolution in both indoor and outdoor conditions. In certain embodiments, a front sheet comprising an array of convex protrusions may be combined with an array of light emitters. In an exemplary embodiment, the light emitters are LEDs. In certain other embodiments, a front sheet including an array of convex protrusions may be combined with an array of LEDs and an embedded sensor technology and an image control system.

In certain embodiments, a front sheet comprising an array of convex protrusions may be combined with an array of inorganic LEDs, organic light emitting diodes (OLEDs), polymer light emitting diodes (PLEDs), micro-LEDs or quantum dots and a medium further comprising electrophoretic particles. In certain other embodiments, a hybrid display may comprise a front sheet comprising of an array of convex protrusions, an array of LEDs, OLEDs or micro-LEDs, a medium comprising electrophoretically mobile particles, a color filter array, an ambient light sensor and an image control system for a full color reflective and emissive display.

In exemplary embodiments, the array of convex protrusions have a refractive index in the range of about 1.4-1.9 and the medium comprising electrophoretic particles or electrowetting fluids may have a refractive index in the range of about 1-1.5. The electrophoretic mobile particles may be used as a reflection control mechanism.

The light emitters having controllable luminance comprise sources with highly saturated chromaticity or saturation in order to supplement the weak color saturation arising from the use of the higher transmission color filters required for a reasonable level of reflectance. The ambient light sensor and image control system takes into account ambient light level in order to optimize the quality of the image while minimizing the use of electrical power. The image control system further minimizes the use of electrical power by employing the light emitters only in situations where the desired color cannot be achieved through the use of reflected light and reflectance control.

The image produced by the display may be analyzed on a pixel-by-pixel basis to ensure that it simultaneously achieves the most efficient and optimal (most saturated/colorful) image. An appropriate image controller identifies the desired image characteristics of each subpixel and applies the correct control signal to both the emissive component control and the reflective component control of each subpixel to achieve the desired accuracy and saturation of color in the overall image.

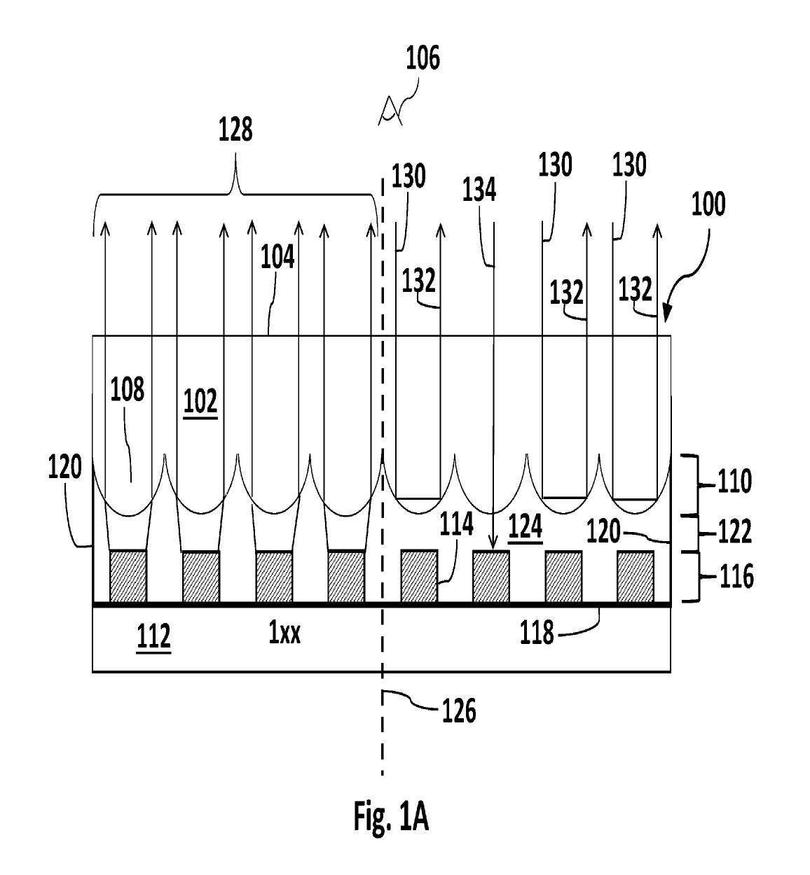

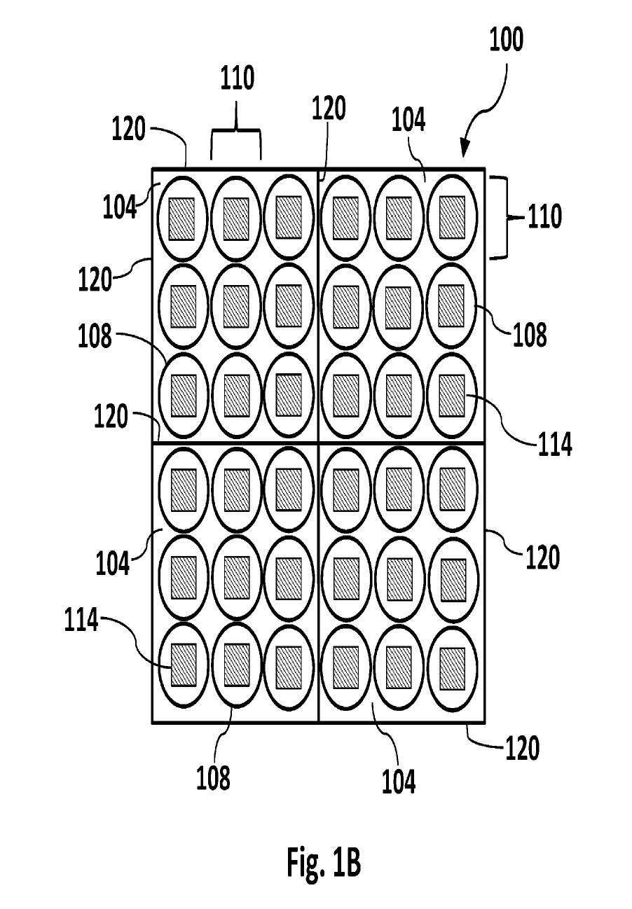

FIG. 1A schematically illustrates a cross-section of a hybrid reflective-emissive image display according to one embodiment of the disclosure. Hybrid display embodiment 100 in FIG. 1A may include a transparent front sheet 102 with outer surface 104 facing viewer 106. Sheet 102 may further include at least one convex protrusion 108 on the inward side. While protrusions are shown, the inward surface may be substantially flat in other exemplary embodiments. Sheet 102 may include a plurality of convex protrusions 110 arranged in a layer on the inward side. The protrusions may have a diameter of at least about 0.5 micron. In some embodiments the protrusions may have a diameter in the range of about 0.5-5000 microns. In other embodiments the protrusions may have a diameter in the range of about 0.5-500 microns. In still other embodiments the protrusions may have a diameter in the range of about 0.5-100 microns. The protrusions may have a height of at least about 0.5 micron. In some embodiments the protrusions may have a height in the range of about 0.5-5000 microns. In other embodiments the protrusions may have a height in the range of about 0.5-500 microns. In still other embodiments the protrusions may have a height in the range of about 0.5-100 microns. In certain embodiments, the protrusions may include materials having a refractive index in the range of about 1.4 to 2.2. In certain other embodiments, the high refractive index protrusions may comprise a material having a refractive index of about 1.4 to about 1.9. In still other embodiments, the high refractive index protrusions may comprise a material having a refractive index of about 1.6 to about 1.9. In some embodiments, front sheet 102 and protrusions 110 may be a continuous sheet of substantially the same material. In other embodiments, front sheet 102 and protrusions 110 may be formed of different materials having similar or different refractive indices. In an exemplary embodiment, front sheet 102 may comprise glass. Front sheet 102 may comprise a polymer such as polycarbonate. In an exemplary embodiment, protrusions 110 may comprise a high refractive index polymer. Protrusions 110 may comprise one or more of a silicone, acrylate, urethane, methacrylate, triazine or diethynylbenzene. High refractive index polymers that may be used may comprise high refractive index additives such as metal oxides. In an exemplary embodiment, the metal oxides may comprise one or more of ZrO₂, ZnO₂, ZnO, SiO₂ or TiO₂. In some embodiments, the convex protrusions 110 may be in the shape of hemispheres as illustrated in FIG. 1A.

Protrusions 110 may be of any shape or size or a mixture of shapes and sizes. Protrusions 110 may be elongated hemispheres or hexagonally shaped or a combination thereof. In some embodiments, the convex protrusions may be randomly sized and shaped. In some embodiments the protrusions may be faceted at the base and morph into a smooth hemispherical or circular shape at the top. In other embodiments, protrusions 110 may be hemispherical or circular in one plane and elongated in another plane. In some embodiments, front sheet 102 and layer of convex protrusions 110 may be a continuous layer. In an exemplary embodiment, the convex protrusions 110 may be manufactured by micro-replication. In some embodiments, the protrusions may comprise beads or hemi-beads embedded in a substrate. The beads and substrate may comprise of the same material or different materials. The beads and substrate may have substantially the same refractive indices or different refractive indices.

Hybrid display 100 may comprise a rear support sheet 112. Sheet 112 may comprise one or more of a metal, polymer, ceramic, wood or other material. Sheet 112 may include one or more of glass, polycarbonate, polymethylmethacrylate (PMMA), polyurethane, acrylic, polyvinylchloride (PVC) or polyethylene terephthalate (PET). Sheet 112 may be rigid or flexible. In some embodiments sheet 112 may further include an adhesive layer. The adhesive layer may comprise of a polymer. The adhesive layer may include one or more of a solvent-based adhesive, emulsion adhesive, polymer dispersion adhesive, pressure-sensitive adhesive, contact adhesive, hot-melt adhesive, multi-component adhesive, ultra-violet (UV) light curing adhesive, heat curing adhesive, moisture curing adhesive, natural adhesive or any other synthetic adhesive. In still other embodiments, sheet 112 may further comprise an adhesive layer and a release sheet. The release sheet may be readily removed to expose the adhesive layer where display 100 may be adhered or laminated to any structure or location where the display is desired.

Hybrid display 100 may further include at least one light emitting structure 114. In an exemplary embodiment, hybrid display 100 comprises an array of light emitters 116. Light emitters 114 may comprise one or more of OLEDs, PLEDs, inorganic LEDs, micro-LEDS or quantum dots or other light emitting structures. In some embodiments, light emitting structures 114 may emit light of one or the same wavelength. In other embodiments, light emitting structures may emit light of different wavelengths or color. Light emitting structures may emit one or more of colors, red, green, blue, white, cyan, magenta or yellow. The light emitting structures 114 may have controllable luminance that comprises sources with highly saturated chromaticity or saturation in order to supplement the weak color saturation that may arise from the use of the higher transmission color filters required for a reasonable level of reflectance. In some embodiments, the array of light emitting structures 116 may emit light of different colors in a random array. In other embodiments, the array of light emitting structures 116 may emit light in a patterned array. In some embodiments, light emitting structures 114 in array 116 may emit light of the same intensity. In other embodiments, light emitting structures 114 in array 116 may emit light of different intensities. Light emitters 114 may have a controllable luminance, radiance or intensity. In some embodiments, light emitters 114 may be spaced substantially equal distances apart. In other embodiments, light emitters 114 may be spaced at varying distances apart. In an exemplary embodiment, at least one emitter 114 may be aligned with at least one convex protrusion 108 as illustrated in FIG. 1A. Light emitters 114 may be oriented in combination with the shape of the transparent convex protrusions. At least one light emitter 114 may be substantially aligned with the apex of a convex protrusion 108 (this is illustrated in FIG. 1A where a light emitter 114 is aligned directly below the apex of each protrusion 108). Light emitters 114 may be tuned to center the region of brightest emission toward the most useful direction. In some embodiments, this may be about 10 to 20 degrees below perpendicular (where the perpendicular direction is a straight on view of the display). About 10 to 20 degrees below perpendicular from the viewing direction is typically the view from which viewers find most comfortable and convenient if the display is, for example, lying on a table top in front of the viewer and viewer is looking down onto the display at an angle. The center of the region of brightest semi-retro-reflection may be similarly tuned by appropriate optical structuring of the convex protrusions.

Light emitting devices 114 may further comprise a barrier layer. The barrier layer may protect the light emitting devices from degradation leading to a longer display life. The barrier layer may comprise one or more of a polymer or glass.

In an exemplary embodiment, hybrid display embodiment 100 in FIG. 1A may comprise an electrode layer 118. Layer 118 may provide electrical power to provide power to light emitting structures 114. Layer 118 may comprise one or more of a thin film transistor (TFT) array, a passive matrix array of electrodes or a direct drive patterned array of electrodes to provide power to light emitters 114. Hybrid display embodiment 100 in FIG. 1A may comprise a power source. The power source may provide power to layer 118 to operate emitters 114.

Hybrid display embodiment 100 in FIG. 1A may comprise walls 120. Walls 120 may provide support to the display. Walls 120 may aid in keeping a substantially uniform distance 122 between the layer of light emitters 116 and the inward surface of the layer of the plurality of convex protrusions 110. In some embodiments, walls 120 may provide rigidity to display 100. Walls 120 may comprise one or more of a polymer, glass or metal. In some embodiments, walls 120 may be continuous with front sheet 102. In other embodiments, walls 120 may be continuous with rear sheet 112. In some embodiments, walls 120 may further comprise a light reflecting layer to prevent absorption and loss of light in order to substantially optimize the brightness of the display. Walls 120 may form compartments to contain a low refractive index medium such as a liquid, air or other gas 124. In an exemplary embodiment, medium 124 may have a refractive index in the range of about 1-1.5. In an exemplary embodiment, medium 124 is air.

Hybrid display embodiment 100 may further comprise a colored overlay (interchangeably, colored layer). The colored layer may be located on outward surface 104 of sheet 102 facing viewer 106. The colored layer may impart at least one color to the display. The colored layer may act as a color filter. The colored layer may be continuous or patterned to convey information to a viewer. In other embodiments, display 100 may further comprise a color filter array. The color filter array may be located on the outward surface 104 of sheet 102. In an exemplary embodiment, the color filter array may be located between the layer of convex protrusions 110 and sheet 102. The color filter array may comprise of filters of one or more of colors red, green, blue, cyan, magenta, yellow or white.

Hybrid display embodiment 100 may further comprise an optional transparent outer protective layer or coating. The protective layer may be located on outer surface 104 of sheet 102 facing viewer 106. The protective layer may protect the display from one or more of physical damage, thermal damage or UV-light damage. The protective layer may also comprise at least one color in a continuous or patterned manner. Display embodiment 100 may comprise a colored layer and a protective layer.

Hybrid display embodiment 100 may further comprise one or more of a sensor or an image control system. In some embodiments, the sensor may be capable of detecting the intensity of ambient light. In other embodiments, the sensor may be able to detect the color of the ambient light. In an exemplary embodiment, the sensor is an ambient light sensor (ALS) device. The ALS may convert light energy to a voltage or current signal.

An image control system may optionally be added to control the dimming or brightness control of the hybrid display in order to reduce power consumption, extend battery life and provide optimal viewing in varying and diverse lighting conditions. An exemplary image control system may communicate with one or more ALS and determine whether to increase or decrease luminescence of the internal light emitting source(s). The image control system may take into account ambient light level in order to optimize the quality of the image while minimizing the use of electrical power. The image control system may further minimize the use of electrical power by employing light emitters 114 only in situations where the desired color may be achieved through the use of reflected light and reflectance control. For example, this may be in regions of the display that have very high brightness and/or color saturation. Since high brightness and high color saturation regions of the display may be rare in most images, this may only be needed, on average, rarely, so this may represent a substantial additional savings in electrical energy use.

In some embodiments, the image control system may correct the color of the display that the viewer observes based on the color of the ambient lighting detected by a sensor. In other embodiments, the image produced by the display may be analyzed on a pixel-by-pixel basis to ensure that it simultaneously achieves the most efficient and optimal (i.e. most saturated and colorful) image. An appropriate image controller may identify the desired image characteristics of each subpixel. The image control system may apply the correct control signal to both the emissive component control and the reflective component control of each subpixel to achieve the desired accuracy and saturation of color in the overall image. In some embodiments, the sensor and image control system may further comprise a power source or may communicate with a power source.

In an exemplary implementation, the hybrid display embodiment 100 may operate as follows. A sensor may detect low ambient lighting conditions. The sensor may then send a signal, such as a voltage or current, to the image control system of the display in order for the display to “turn on” and emit light. It may also send a signal to dim an existing emitted light. The display may emit light in order for the display to become more visible to a viewer. The intensity of the emitted light may also be controlled by the sensor based on the brightness level of the ambient light. In dimmer conditions the intensity of light emission may be increased. In brighter conditions the intensity may be decreased to the level where the display may be turned off. This is represented on the left side of dotted line 126 in FIG. 1A. Light emitters 114 may emit light rays 128 that pass through the layer of convex protrusions 110 and sheet 102 and exit the display. In an exemplary embodiment, convex protrusions 108 may further collimate the emitted light. The protrusions may magnify the apparent size of light emitters 114 and collimate the light towards viewer 106.

In bright ambient lighting conditions, a sensor may send a signal to the image control system to “turn off” the light emitters. Emissive displays can become difficult to see in bright conditions. In bright ambient lighting conditions the array of convex protrusions 110, represented as an array of hemispherical protrusions in FIG. 1A, become highly visible to viewer 106 due to retro-reflection of light rays. This is represented in FIG. 1A on the right side of dotted line 126. On the right side of dotted line 126, light emitters 114 are turned off. This may be done under bright ambient lighting conditions where incident ambient light rays 130 may be retro-reflected as representative light rays 132 back towards viewer 106. Some incident light rays may pass through front sheet 102 and the dark pupil regions of layer of convex protrusions 110 at an angle less than the critical angle to allow for TIR. This is represented by incident light ray 134. This light may be lost or may be reflected back towards viewer 106 if a reflected layer is added to rear sheet 112.

FIG. 1B schematically illustrates a top view of a hybrid reflective-emissive image display according to one embodiment of the disclosure. FIG. 1B is the same embodiment 100 as shown in FIG. 1A but is a top view of the display facing outer surface 104 to better illustrate the embodiment. In this embodiment, the hemispherical protrusions 108 are arranged in rows 110 with substantially the same distance between each protrusion 108. Protrusions 108 but may be arranged in other designs such as close packed arrays to minimize the void space between the protrusions. Protrusions 108 may also be divided by optional support walls 120. The walls may provide stability and rigidity to the display. In embodiment 100 in FIG. 1B a light emitter 114 may be substantially aligned behind each convex protrusion 108. In other embodiments, light emitters 114 may not be substantially aligned with convex protrusions 108. In still other embodiments a portion of light emitters 114 may be substantially aligned with convex protrusions 108 and a portions of the light emitters 114 may not be substantially aligned with convex protrusions 108.

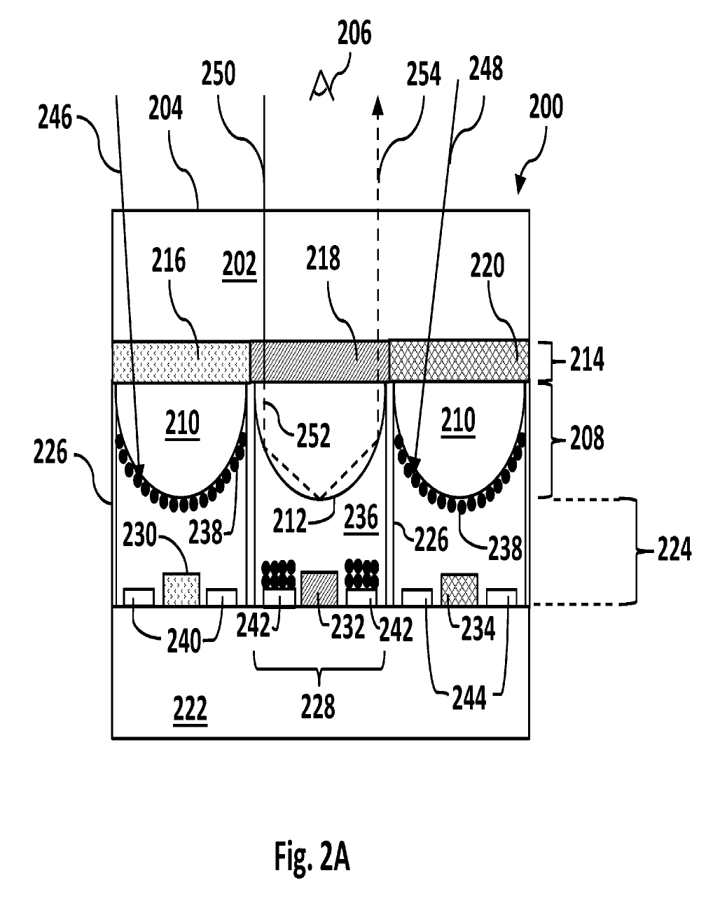

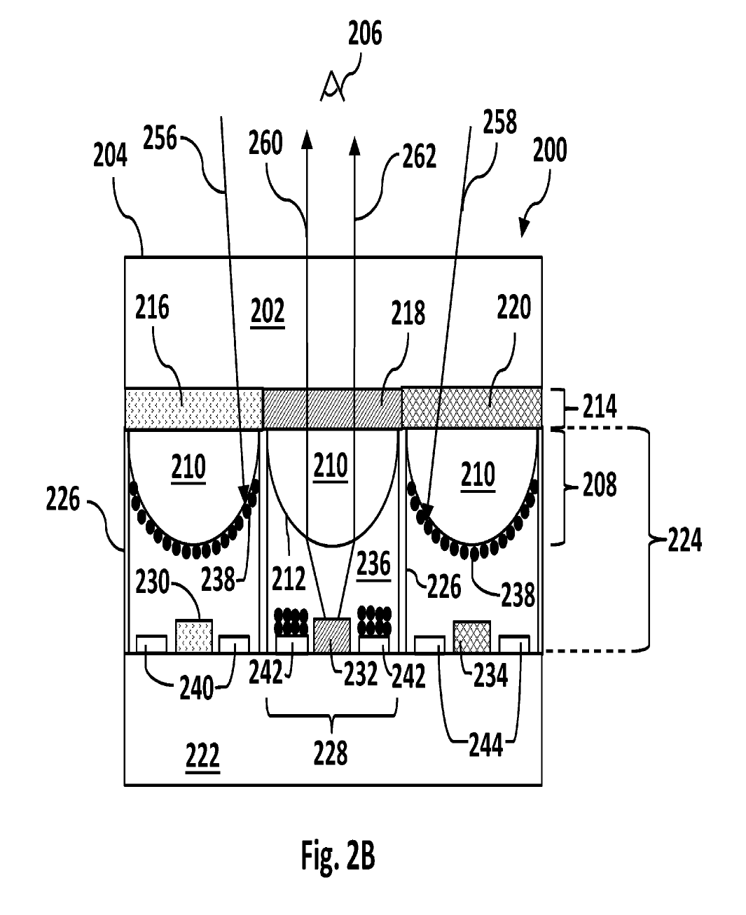

FIG. 2A schematically illustrates a cross-section of a pixel of a hybrid reflective-emissive image display reflecting ambient light according to one embodiment of the disclosure. Hybrid display embodiment 200 may include a plurality of pixels aligned in arrays. Only a pixel will be illustrated to describe an embodiment. Display embodiment 200 in FIG. 2A comprises transparent front sheet 202 with an outward surface 204 facing viewer 206. The inward side of front sheet 202 comprises a plurality 208 of individual high refractive index hemispherical convex protrusions 210. The protrusions may have a diameter of at least about 0.5 micron. In some embodiments, the protrusions may have a diameter in the range of about 0.5-5000 microns. In other embodiments, protrusions 210 may have a diameter in the range of about 0.5-500 microns. In still other embodiments, the protrusions may have a diameter in the range of about 0.5-100 microns. Protrusions 210 may have a height of at least about 0.5 micron. In some embodiments, the protrusions may have a height in the range of about 0.5-5000 microns. In other embodiments the protrusions may have a height in the range of about 0.5-500 microns. In still other embodiments, protrusions 210 may have a height in the range of about 0.5-100 microns. In certain embodiments, protrusions 210 may include materials having a refractive index in the range of about 1.4 to 2.2. In certain other embodiments, the high refractive index protrusions may be a material having a refractive index of about 1.4 to about 1.9. In exemplary embodiments, the high refractive index protrusions may be a material having a refractive index of about 1.6 to about 1.9. In some embodiments, front sheet 202 and protrusions 210 may be a continuous sheet of substantially the same material. In other embodiments, front sheet 202 and protrusions 210 may be formed of different materials having similar or different refractive indices. In an exemplary embodiment, front sheet 202 may comprise glass. Front sheet 202 may comprise a polymer such as polycarbonate. In an exemplary embodiment, protrusions 210 may comprise a high refractive index polymer. Protrusions 210 may include one or more of a silicone, acrylate, methacrylate, urethane, triazine or diethynylbenzene. High refractive index polymers that may be used may comprise high refractive index additives such as metal oxides. In an exemplary embodiment, the metal oxides may comprise one or more of ZrO₂, ZnO₂, ZnO, SiO₂ or TiO₂. The refractive index of protrusions 210 may be greater than about 1.4. In some embodiments, the convex protrusions 210 may be in the shape of hemispheres as illustrated in FIG. 2A. Protrusions 210 may be of any shape or size or a mixture of shapes and sizes. Protrusions 210 may be elongated hemispheres or hexagonally shaped or a combination thereof.

In some embodiments, the convex protrusions may be randomly or orderly sized and shaped. In some embodiments the protrusions may be faceted at the base and morph into a smooth hemispherical or circular shape at the top. In other embodiments, protrusions 210 may be hemispherical or circular in one plane and elongated in another plane. In some embodiments, front sheet 202 and layer of convex protrusions 210 may be a continuous layer. In an exemplary embodiment, the convex protrusions 210 may be manufactured by micro-replication. In some embodiments, the protrusions may comprise beads or hemi-beads embedded in a substrate. The beads and substrate may comprise of the same material or different materials. The beads and substrate may have substantially the same refractive indices or different refractive indices.

The surface of the plurality of convex protrusions 210 may further comprise a transparent front electrode layer 212. The front electrode layer 212 may comprise of one or more of indium tin oxide (ITO), an electrically conducting polymer such as BAYTRON™ or conductive nanoparticles, metal nanowires, graphene or other conductive carbon allotropes or a combination of these materials dispersed in a substantially transparent polymer.

Hybrid display embodiment 200 may optionally include color filter layer 214. Color filter layer 214 may comprise an array of red, green, blue or cyan, magenta, yellow or other combination of color filters. Display embodiment 200, for illustrative purposes, comprises an array of red 216, green 218 and blue filters 220. In an exemplary embodiment, the color filters may have a medium level of saturation. In an exemplary embodiment, the color filter layer 214 may be interposed between layer of convex protrusions 208 and transparent sheet 202. In some embodiments, the color filter layer may be located on surface 204 of sheet 202.

Hybrid display embodiment 200 may include a rear support sheet 222 opposing the surface of the plurality of convex protrusions 208. This may form a cavity or gap 224 with the plurality of convex protrusions 208. Sheet 222 may comprise one or more of a metal, plastic, wood or other material. Sheet 222 may comprise one or more of glass, polycarbonate, polymethylmethacrylate (PMMA), polyurethane, acrylic, polyvinylchloride (PVC) or polyethylene terephthalate (PET). Sheet 222 may be rigid or flexible. In some embodiments sheet 222 may further comprise an adhesive layer. The adhesive layer may comprise a polymer. The adhesive layer may comprise one or more of a solvent-based adhesive, emulsion adhesive, polymer dispersion adhesive, pressure-sensitive adhesive, contact adhesive, hot-melt adhesive, multi-component adhesive, ultra-violet (UV) light curing adhesive, heat curing adhesive, moisture curing adhesive, natural adhesive or any other synthetic adhesive. In other embodiments, sheet 222 may further comprise an adhesive layer and a release sheet. The release sheet may be readily removed to expose the adhesive layer where display 200 may be adhered or laminated to any structure or location where the display is desired.

Hybrid display embodiment 200 may further comprise sidewalls 226 (interchangeably, cross-walls). Sidewalls 226 may limit particle settling, drift and diffusion to improve display performance and bistability. Sidewalls 226 may completely or partially extend from the plurality of convex protrusions 208, rear support sheet 222 or both the plurality of convex protrusions 208 and rear sheet 222. Sidewalls 226 may comprise one or more of polymer, metal or glass. Sidewalls 226 may create wells or compartments to confine electrophoretically mobile particles or electrowetting fluids. Sidewalls or cross-walls 226 may be configured to create wells or compartments 228 in, for example, square-like, triangular, pentagonal or hexagonal shapes or a combination thereof. Sidewalls 226 may comprise a polymeric material and patterned by conventional techniques including photolithography, embossing or molding. Sidewalls 226 may be uniform in thickness or may be tapered or a combination thereof. For illustrative purposes, sidewalls 226 in hybrid display embodiment 200 completely extend through gap 224 and form individual compartments 228. Sidewalls 226 may comprise a light reflective surface coating.

In an exemplary embodiment, each compartment 228 may be substantially registered or aligned with at least one color filter. Compartments 228 may be aligned with a red 216, green 218 or blue 220 filter or other color to create a sub-pixel. A red sub-pixel, green sub-pixel and blue sub-pixel may be combined to form a single pixel as shown in FIG. 2A. The compartment on the far left in FIG. 2A that is substantially aligned with a red color filter 216 is a red sub-pixel, the compartment in the middle substantially aligned with a green color filter 218 is a green sub-pixel and the compartment on the far right substantially aligned with a blue color filter 220 is a blue sub-pixel.

Each compartment 228 may further comprise one convex protrusion 210 as illustrated in embodiment 200 in FIG. 2A. In some embodiments each compartment 228 may comprise more than one convex protrusion 210. Each compartment 228 may be substantially aligned with a color filter to form a sub-pixel and may further comprise at least one light emitter 230, 232, 234. Light emitter 230, 232, 234 may have a controllable luminance, radiance or intensity. The light emitting device may be substantially aligned at the center of the convex protrusions 210 within each compartment. The compartment on the far left that is aligned with the red filter 216 forming a red sub-pixel comprises light emitting device 230. The compartment in the middle that is aligned with green filter 218 forming a green sub-pixel comprises light emitting device 232 and the compartment on the far right in FIG. 2A that is aligned with the blue color filter forming a blue sub-pixel comprises light emitting device 234. Light emitters 230, 232, 234 may comprise one or more of OLEDs, PLEDs, inorganic LEDs, micro-LEDS or quantum dots or other light emitting structures. In an exemplary embodiment, the light emitting device 230 in the compartment on the far left in FIG. 2A and aligned with a red color filter 216 emits red light. The light emitting device 232 in the middle compartment in FIG. 2A and aligned with a green color filter 218 emits green light. The light emitting device 234 in the far right compartment in FIG. 2A and aligned with a blue color filter 220 emits blue light.

In an exemplary embodiment, the light emitting devices may emit light with high color saturation of approximately the same hue as the color filters. In some embodiments, light emitting structures 230, 232, 234 may emit light of the same color or wavelength. In other embodiments, light emitting structures may emit light of different wavelengths or color. The light emitting structures may emit one or more of colors red, green, blue, white, cyan, magenta or yellow. Light emitting structures 230, 232, 234 may have controllable luminance that comprises sources with highly saturated chromaticity or saturation in order to supplement the weak color saturation that may arise from the use of the higher transmission color filters required for a reasonable level of reflectance. In some embodiments, the array of light emitting structures 230, 232, 234 may emit light of different colors in a random array. In other embodiments, array of light emitting structures 214 may emit light in a patterned array. In some embodiments, light emitting structures 230, 232, 234 in array 214 may emit light of the same intensity. In other embodiments, light emitting structures 230, 232, 234 in array 214 may emit light of different intensities. Light emitters 230, 232, 234 may have a controllable luminance, radiance or intensity. In some embodiments, light emitters 230, 232, 234 may be spaced substantially equal distances apart. In other embodiments, light emitters 230, 232, 234 may be spaced at varying distances apart. In an exemplary embodiment, at least one emitter 230, 232, 234 may be aligned with the apex of at least one convex protrusion 210 as illustrated in FIG. 2A. Light emitters 230, 232, 234 may be oriented in combination with the shape of the transparent convex protrusions. Light emitters 230, 232, 234 may be tuned to center the region of brightest emission toward the most useful direction. This may be about 10 to 20 degrees below perpendicular. The center of the region of brightest semi-retro-reflection may be similarly tuned by appropriate optical structuring of convex protrusions 210. Display 200 may further comprise an electrode layer to provide power to the light emitters. The electrode layer to provide power to the light emitters may comprise one or more of a TFT, passive matrix array of electrodes or a patterned array of electrodes.

Light emitting devices 230, 232, 234 may further comprise a barrier layer. The barrier layer may protect the light emitting devices from degradation leading to a longer display life. The barrier layer may comprise of one or more of a polymer or glass.

Each compartment in hybrid display embodiment 200 in FIG. 2A may further comprise a low refractive index medium 236. Medium 236 may be a gas or a liquid. In some embodiments, medium 236 may be a hydrocarbon. In other embodiments, medium 236 may be a fluorinated hydrocarbon or a perfluorinated hydrocarbon. In other embodiments, medium 236 may be a mixture of a hydrocarbon and a fluorinated hydrocarbon. Medium 236 may be a low refractive index liquid with a refractive index less than about 1.5. In an exemplary embodiment the refractive index of medium 236 may be about 1.1-1.5. In an exemplary embodiment, medium 236 may comprise one or more of Fluorinert™, Novec™ 7000, Novec™ 7100, Novec™ 7300, Novec™ 7500, Novec™ 7700, Novec™ 8200, electrowetting materials, Teflon™ AF, CYTOP™ or Fluoropel™. Medium 236 may further comprise one or more of a dispersant, charging agent, surfactant, flocculating agent, viscosity modifier or a polymer. Conventional viscosity modifiers include oligomers or polymers. Viscosity modifiers may include one or more of a styrene, acrylate, methacrylate or other olefin-based polymers. In one embodiment, the viscosity modifier may be polyisobutylene or a halogenated polyisobutylene.

Medium 236 in embodiment 200 in FIG. 2A may further receive a plurality of light absorbing electrophoretically mobile particles 238 of a first optical characteristic (i.e. color or light absorption characteristic). Particles 238 may include a positive or negative charge polarity. Particles 238 may have broadband (i.e., substantially all optical wavelengths) light reflection characteristics. Particles 238 may also have any light absorption characteristics such that they may impart any color of the visible spectrum or a combination of colors to give a specific shade or hue. Particles 238 may be a dye or pigment or a combination thereof. The particles may be organic or inorganic or a combination thereof. Particles 238 may comprise of a metal oxide. Particles 238 may comprise of carbon black.

In other embodiments, medium 236 may also comprise an electrowetting fluid. In an exemplary embodiment, the electrowetting fluid may comprise a dye. The electrowetting fluid may move towards protrusions 210 to frustrate TIR. The electrowetting fluid may move away from protrusions 210 to allow for TIR. The electrowetting fluid may be a silicone oil that may be pumped via small channels into and out of the wells formed by sidewalls 226.

Hybrid display embodiment 200 may further comprise a rear electrode within each compartment or sub-pixel. In FIG. 2A in the far left compartment comprises rear electrode 240. The middle compartment comprises rear electrode 242 and the far right compartment comprises rear electrode 244. The rear electrodes 240, 242, 244 may comprise one or more of a thin film transistor (TFT) array, patterned direct drive array or a passive matrix array of electrodes. In an exemplary embodiment, the rear electrode in each compartment, pixel or sub-pixel may completely surround the corresponding light emitting device in a circular or square-like fashion or other related design.

In some embodiments an optional dielectric layer may be located on the surface of transparent front electrode 212. In other embodiments an optional dielectric layer may be located on top of at least one of rear electrodes 240, 242, 244. In some embodiments, the dielectric layer on the front electrode may comprise of a different composition than the dielectric layer on the rear electrodes. The dielectric layers may be substantially uniform, continuous and substantially free of surface defects. The dielectric layers may be about 5 nm in thickness or more. In some embodiments, the dielectric layer thickness may be about 5 to 300 nm. In other embodiments, the dielectric layer thickness may be about 5 to 200 nm. In still other embodiments, the dielectric layer thickness may be about 5 to 100 nm. The dielectric layers may each have a thickness of at least about 80 nanometers. In an exemplary embodiment, the thickness may be about 80-200 nanometers. The one or more dielectric layers may comprise at least one pin hole.

The dielectric layer may define a conformal coating and may be free of pin holes or may have minimal pin holes. The dielectric layer may also be a structured layer or a patterned layer. Dielectric compounds may be organic or inorganic in type. In some embodiments the dielectric layer may be alumina (Al₂O₃) or SiO₂. The dielectric layer may be SiNₓ. In some embodiments the dielectric layer may be Si₃N₄. Organic dielectric materials are typically polymers such as polyimides, fluoropolymers, polynorbornenes and hydrocarbon-based polymers lacking polar groups. The dielectric layer may be a polymer or a combination of polymers. The dielectric may comprise silicone polymers or filled silicones, or silicone-based polymers comprising reactive groups. In an exemplary embodiment, the dielectric layers comprise parylene. In other embodiments, the dielectric layers may comprise a halogenated parylene. Other inorganic or organic dielectric materials or combinations thereof may also be used for the dielectric layers.

Hybrid display embodiment 200 of FIG. 2A may further comprise a voltage bias source. The bias source may be used to create an electromagnetic field or flux across medium 236 in compartments 228 between the front electrode 212 and rear electrodes 240, 242, 244. The bias source may be used to move the plurality of particles 238 to the front electrode 212 or rear electrodes 240, 242, 244 or anywhere in between the front and rear electrodes.

Hybrid display of FIG. 2A may further comprise one or more of a sensor and an image control system. In some embodiments, the sensor may be capable of detecting the intensity of ambient light. In other embodiments, the sensor may be able to detect the color of the ambient light. As provided above, the sensor may be an ambient light sensor (ALS). The ALS may convert light energy to a voltage or current signal. The image control system may control the dimming or brightness control of the hybrid display in order to reduce power consumption, extend battery life and provide optimal viewing in varying and diverse lighting conditions.

The image control system may take into account ambient light level in order to optimize the quality of the image while minimizing the use of electrical power. The control system may comprise one or more processor circuitries and associated memory circuitries configured to function as described herein. The image control system may further minimize the use of electrical power by employing light emitters 230, 232, 234 only in situations where the desired color may be achieved through the use of reflected light and reflectance control. For example, this may be in regions of the display that have very high brightness and/or color saturation. Since high brightness and high color saturation regions of the display may be rare in most images, this may only be seldom needed. This may represent a substantial additional savings in electrical energy use. In some embodiments, the image control system may correct the color of the display that the viewer observes based on the color of the ambient lighting detected by a sensor. In some embodiments, the image control system may correct the color of the display that the viewer observes based on the color of the ambient lighting detected by a sensor. In other embodiments, the image produced by the display may be analyzed on a pixel-by-pixel basis to ensure that it simultaneously achieves the most efficient and optimal (i.e. most saturated and colorful) image. An appropriate image control system may identify the desired image characteristics of each subpixel. The image control system may apply a corrective control signal to both the emissive component control and the reflective component control of each subpixel to achieve the desired accuracy and saturation of color in the overall image. It is within the scope of the disclosed principles to supply corrective signals to one or both the emissive component and/or the reflective component.

Hybrid display embodiment 200 may further comprise an optional transparent outer protective layer or coating. The protective layer may be located on outer surface 204 of sheet 202 facing viewer 206. The protective layer may protect the display from one or more of physical damage, thermal damage or UV-light damage. The protective layer may also comprise at least one color in a continuous or patterned manner.

Hybrid reflective-emissive display embodiment 200 may be operated as follows. A sensor, such as an ALS sensor, may detect bright ambient lighting conditions. A voltage or current may be produced in the sensor and sent to the display to turn off or deactivate light emission. As illustrated in FIG. 2A, by applying an appropriate voltage bias of opposite polarity to the charge polarity on the particles 238 in the far left red sub-pixel and the blue sub-pixel on the far right, the light absorbing electrophoretically mobile particles 238 may be moved into the evanescent wave region near the surface of the front electrode layer 212. In this location particles 238 may frustrate TIR and form a dark state of the sub-pixels. Incident light, such as representative light rays 246 and 248, may be absorbed by particles 238. In the middle green sub-pixel the particles 238 may be electrophoretically moved under an applied bias to the rear electrode layer 242 and away from the surface of the hemispherical array 208 where a bias of opposite polarity to the charge polarity of the particles 238 may be applied. Light rays that enter the middle sub-pixel may be totally internally reflected back towards viewer 206. As ambient light rays pass through the green color filter 218 in the middle sub-pixel, only green light rays may pass through and be totally internally reflected. The display thus appears green to the viewer. An incident light ray at the middle sub-pixel is represented by solid line 250. The filtered light after passing through color filter 218 is represented by dotted line 252 that is totally internally reflected. The light that is reflected back towards viewer 206 is represented by green light ray 254.

FIG. 2B schematically illustrates a cross-section of a pixel of a hybrid reflective-emissive image display emitting green light according to one embodiment of the disclosure. The hybrid display pixel embodiment in FIG. 2B is the same as the hybrid display pixel in FIG. 2A but is in a different state. Here, a sensor may detect low ambient lighting conditions which may send a signal to the display.

In FIG. 2B like that in FIG. 2A, particles 238 may be electrophoretically moved under an appropriate bias to near front electrode 212 at the surface of the plurality of convex protrusions 208 in the far left red sub-pixel and far right blue sub-pixel. In this location particles 238 may absorb light and frustrate TIR. This is represented by absorbed incident light rays 256 and 258. In the middle sub-pixel, under an appropriate voltage bias particles 238 may be moved to rear electrode layer 242. The green light emitting device 232 may emit green light that passes through layer 208, green filter 218 and transparent outer sheet 202 towards viewer 206. Emitted green light rays are represented by rays 260 and 262. In this instance, hybrid display 200 is also producing a green appearance like in FIG. 2A but instead by means of emitting green light from a light emitter. This would be appropriate in the absence of ambient illumination. An additional feature of the design illustrated in FIGS. 2A-B is that the hemispherical protrusions may exhibit a lens-like character which may partially collimate the light from light emitters 230, 232, 234 into the perpendicular direction. This may increase the apparent brightness of the display.

The reflective state method described and illustrated in FIG. 2A may be most applicable to higher ambient light levels. The emitting case method described and illustrated in FIG. 2B may be most applicable to lower ambient light levels. For a wide range of intermediate light levels, there may be significant advantages to intelligently blending these two methods. A control system may be employed to detect ambient light levels to determine and control when the display may be operated in the reflective mode and when it should be operated in an emissive mode or somewhere in between in order to optimize the quality of the image while minimizing the use of electrical power.

In one embodiment, the hybridization design may enable key synergies between the two display modalities of reflectance and emittance. Some exemplary synergies include:

(1) Since conventional light emitters have high color saturation or chroma, they may be used to enhance the color saturation or chroma of regions of the display image where it may be needed. Since this will generally be a very small fraction of a typical image, on average this may not require an undue use of electrical power;

(2) The possibility of moving the light absorption mechanism out of the optical path when it is not needed is highly advantageous for efficient light emission, because absorption may be introduced only when it is needed. This is a stark contrast to the situation with purely emissive displays which have light absorption built-in at all times in order to produce a deeper color in the presence of bright ambient lighting;

(3) The lens-like effect of the hemispherical protrusions may increase the apparent luminance of the light sources, further reducing lighting energy requirements;

(4) The light absorption of the color filter array may further reduce the challenge with reflection of high level ambient light but in so doing absorbs very little of the light from the associated light emitters because of their hue match;

(5) The light emitting devices may react extremely quickly to changes in image content whereas some electrophoretic systems may be slower, so optimal hybrid video control algorithms may yield excellent video response while minimizing the use of electrical lighting during periods of relative image stability;

(6) A great degree of control of the light and emissive character of the light emitting devices such as LEDs may be used to compensate for errors in reflection arising from hysteresis or other non-ideologies associated with the control of reflection using electrophoresis;

(7) Since light emitting diodes may be used to increase the apparent brightness in regions where the image is intended to produce a true white appearance, this means that the overall required degree of reflectance from the reflective imaging system need not be as high as would otherwise be the case. This may allow the use of simpler electrophoresis systems having greater long-term stability, lower-cost, and/or more rapid response rates; and

(8) The image produced by the display may be analyzed on a pixel-by-pixel basis to ensure that the display simultaneously achieves the most efficient and optimal (i.e., most saturated and colorful) image. An appropriate image display controller may identify the desired image characteristics of each subpixel. The image display controller may apply the correct control signal to both the emissive component control and the reflective component control of each subpixel to achieve the desired accuracy and saturation of color in the overall image.

The advantages described above may be applied in a wide variety of forms of hybridization of reflective display technologies and emissive display technologies. Thus the embodiments described herein may not be limited to the specific embodiments described herein and illustrated in FIGS. 1A-B, 2A-B.

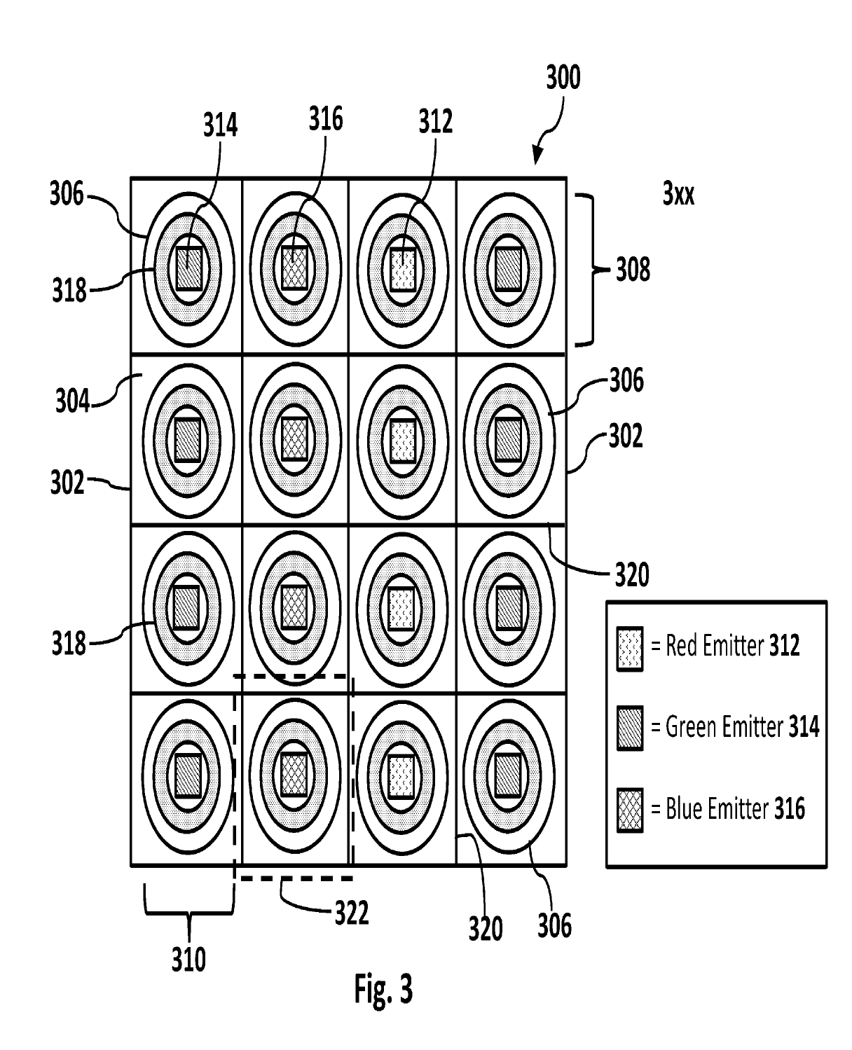

FIG. 3 schematically illustrates and an overhead view of a portion of a hybrid reflective-emissive display according to one embodiment of the disclosure. Embodiment 300 illustrated in FIG. 3 is one embodiment of a design of a hybrid reflective-emissive display. The view in FIG. 3 is facing the outer surface 304 of a transparent front sheet 302. The high refractive index hemispherical protrusions 306 in this embodiment are arranged in substantially equally spaced rows 308 and columns 310 for illustrative purposes only. Other arrangements of the convex protrusions are possible. In an exemplary embodiment, the convex protrusions may be arranged in a close packed array. Substantially aligned with each protrusion may be a light emitting structure 312, 314, 316. The light emitting structures may be arranged in the order of red 312, green 314 and blue 316. Other arrangements of the light emitting structures may be possible. In some embodiments, the light emitting structures may comprise one or more of a cyan, magenta, yellow or green light emitter. In an exemplary embodiment, the light emitters may comprise one or more of a red, green, blue and white emitter.

Surrounding each light emitting structure 312, 314, 316 is a rear electrode 318. Rear electrode 318 in FIG. 3 is depicted as a circular structure though other designs may be possible. Embodiment 300 may further comprise sidewalls 320 to surround each convex protrusion. The sidewalls may confine a low refractive index medium and at least one electrophoretically mobile particle (the medium and particles have been omitted for clarity). The sidewalls may further comprise a light reflective coating.

Display embodiment 300 in FIG. 3 may further comprise a color filter layer (the color filter layer has been omitted for clarity). In an exemplary embodiment, a color filter may be substantially aligned over each convex protrusion. This is represented by the dashed line box 322 illustrating where a color filter layer may reside. In some embodiments, a Bayer filter arrangement of red, green and blue filters may be used. In other embodiments, a red, green, blue and white arrangement of filters may be used. In still other embodiments, a color filter comprising one or more of cyan, magenta, yellow and green may be used.

Various control mechanisms for the disclosed embodiments may be implemented fully or partially in software and/or firmware. This software and/or firmware may take the form of instructions contained in or on a non-transitory computer-readable storage medium. Those instructions may then be read and executed by one or more processors to enable performance of the operations described herein. The instructions may be in any suitable form, such as but not limited to source code, compiled code, interpreted code, executable code, static code, dynamic code, and the like. Such a computer-readable medium may include any tangible non-transitory medium for storing information in a form readable by one or more computers, such as but not limited to read only memory (ROM); random access memory (RAM); magnetic disk storage media; optical storage media; a flash memory, etc.

In some embodiments, a tangible machine-readable non-transitory storage medium that contains instructions may be used in combination with the disclosed display embodiments. In other embodiments, the tangible machine-readable non-transitory storage medium may be further used in combination with one or more processors.

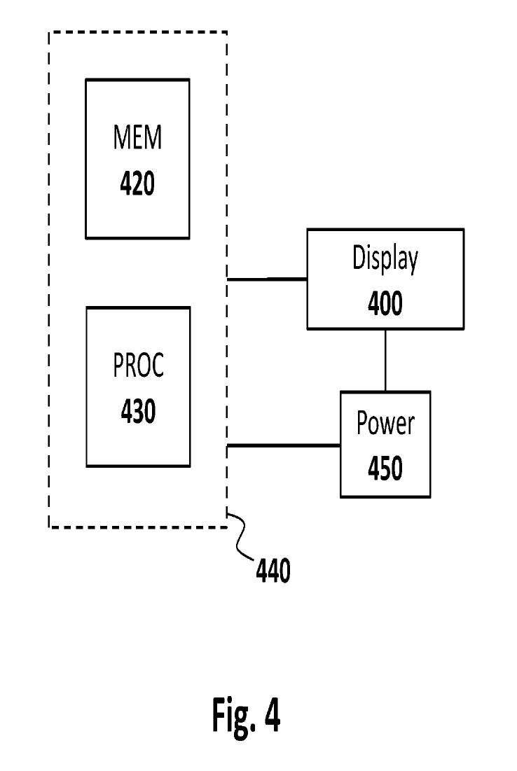

FIG. 4 schematically illustrates an exemplary system for implementing an embodiment of the disclosure. In FIG. 4, display 400 is controlled by controller 440 having processor 430 and memory 420. Other control mechanisms and/or devices may be included in controller 440 without departing from the disclosed principles. Controller 440 may define hardware, software or a combination of hardware and software. For example, controller 440 may define a processor programmed with instructions (e.g., firmware). Processor 430 may be an actual processor or a virtual processor. Similarly, memory 420 may be actual memory (i.e., hardware) or virtual memory (i.e., software).

Memory 420 may store instructions to be executed by processor 430 for driving display 400. The instructions may be configured to operate display 400 by effectively switching or changing the applied bias and the duration of the bias to one or more of the front and rear electrodes. In one embodiment, the instructions may include biasing electrodes associated with display 400 (not shown) through power supply 450. When biased, the electrodes may cause movement of electrophoretic particles towards or away from a region proximal to the surface of the plurality of protrusions at the inward surface of the front transparent sheet to thereby absorb or reflect light received at the inward surface of the front transparent sheet. By appropriately biasing the electrodes, particles (e.g., particles 238 in FIGS. 2A-B) may be moved near the surface of the plurality of protrusions at the inward surface of the front transparent sheet into or near the evanescent wave region in order to substantially or selectively absorb or reflect the incoming light. Absorbing the incoming light creates a dark or colored state. By appropriately biasing the electrodes, particles (e.g., particles 238 in FIGS. 2A-B) may be moved away from the surface of the plurality of protrusions at the inward surface of the front transparent sheet and out of the evanescent wave region in order to reflect or absorb the incoming light. Reflecting the incoming light creates a light state.

In another embodiment, the instructions may be configured to operate the light emitting devices such as LEDs of display 400. In an exemplary embodiment, the instructions may be configured to operate the light emitting devices and to bias electrodes to electrophoretically move the particles to modulate the reflectance of the display.

At least one edge seal may be employed with the disclosed display embodiments. The edge seal may prevent ingress of moisture or other environmental contaminants from entering the display. The edge seal may be used to seal the front sheet to the rear sheet. The edge seal may be a thermally, chemically or a radiation cured material or a combination thereof. The edge seal may comprise one or more of an epoxy, silicone, polyisobutylene, acrylate, urethane, a photopatternable material such as a photoresist or other polymer based material. In some embodiments the edge seal may comprise a metallized foil. In some embodiments the edge sealant may comprise a filler, such as SiO₂ or Al₂O₃.

In other embodiments, any of the hybrid image displays described herein may further include a light diffusive layer to soften the reflected or emitted light observed by the viewer. In other embodiments a light diffusive layer may be used in combination with a front light. The light diffusive layer may comprise one or more of glass or a polymer.

In other embodiments, any of the hybrid image displays described herein may further include at least one spacer unit. The at least one spacer unit may control the spacing of the gap or cavity between the front and rear sheets. The at least one spacer unit may be comprised of one or more of glass, plastic or metal.

In the display embodiments described herein, they may be used in such applications such as in, but not limited to, electronic book readers, portable computers, tablet computers, cellular telephones, smart cards, signs, watches, wearables, shelf labels, flash drives, motorized vehicle signs outdoor billboards, traffic signs, menu boards, kiosks, advertising signs, road markings, emergency signs or other outdoor signs comprising a display.

The display embodiments described herein may be powered by one or more of a battery, solar cell, wind, electrical generator, electrical outlet, AC power, DC power or other means.

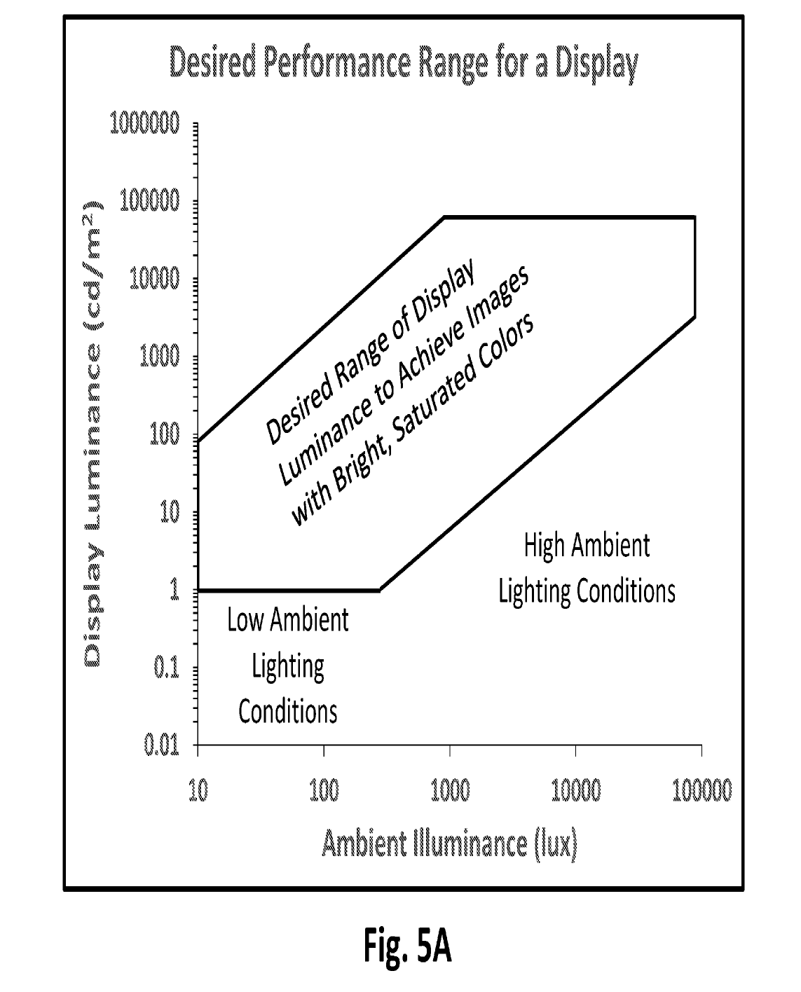

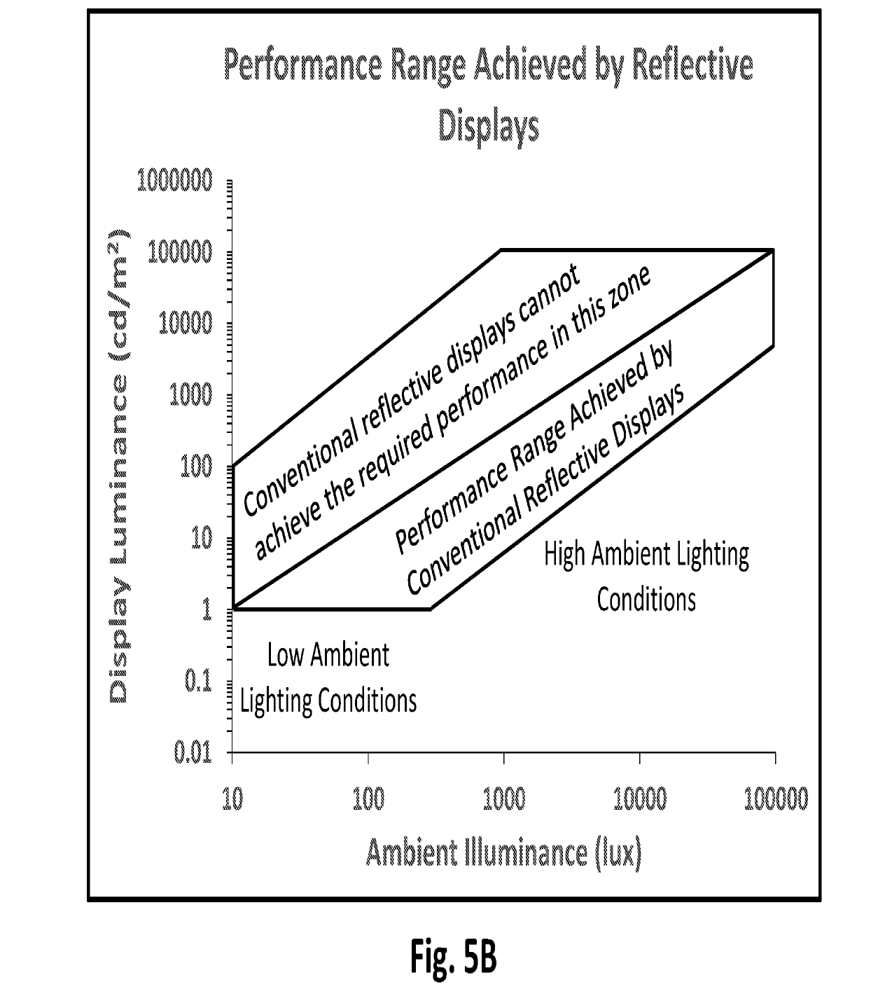

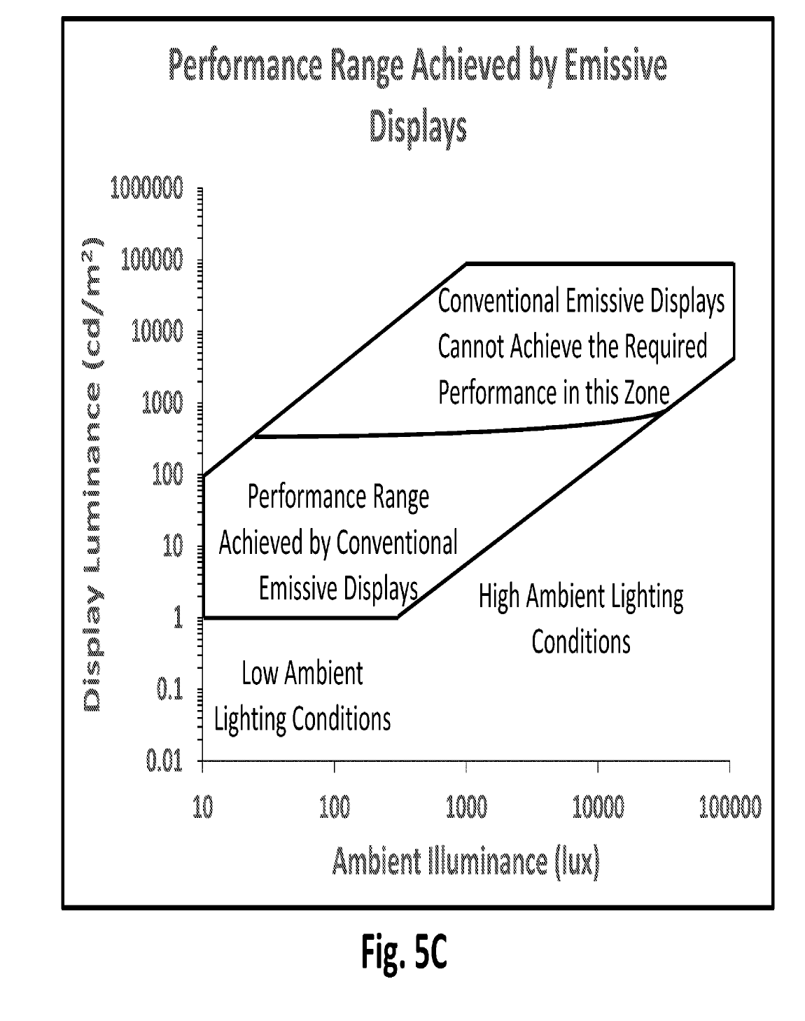

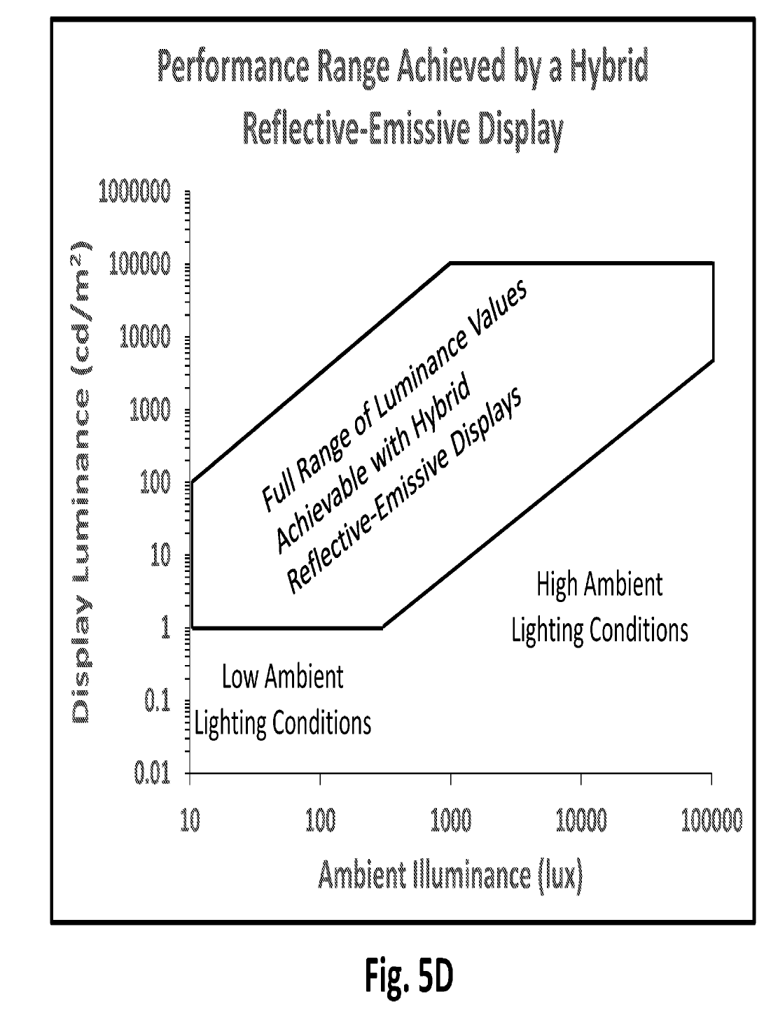

To support and illustrate the advantages of the hybrid reflective-emissive display embodiments described herein, a series of plots shown in FIGS. 5A-D have been created to qualitatively analyze and compare the performance of conventional reflective and emissive display with a hybrid reflective-emissive display. FIG. 5A illustrates the range of display luminance, as a function of the ambient illuminance that is required for an image display to show bright, saturated color images. FIG. 5A plots ambient illuminance in lux on the x-axis versus the resulting display luminance in candela per square meter (cd/m²) on the vertical y-axis. Ambient illuminance is a measure of the brightness of ambient light onto the surface of a display. Display luminance is the measure of the light reflected or emitted from the display.

It is considered that low ambient illuminance, such as at night or in a darkened room, is about 100 lux or less. For comparison, typical lighting in an office provides about 300 lux. High ambient lighting conditions are greater than about 1000 lux. Both regions of low and high ambient lighting are labeled in the plot. Moderate ambient lighting conditions (not labeled in the plot) are greater than about 100 lux and less than about 1000 lux. The desired performance range for an image display is labeled in the plot as “Desired range of display luminance to achieve images with bright, saturated colors”.

The lower limit of the desired range is determined by the eye's ability to distinguish black levels. A viewer cannot see any difference in black levels below 1 cd/m² (i.e. a region of an image with a luminance of 1 cd/m² looks just as black as a region with a luminance of 0.1 cd/m²) so there is no need for the display performance to extend below 1 cd/m². The upper level is determined by the maximum luminance level that is comfortable to view. In a dark ambient environment (˜10 lux), a display brightness of more than 100 cd/m² would be uncomfortably bright. As the ambient illuminance increases, a viewer may comfortably view a brighter display so the upper limit of the desired display luminance range increases, but it reaches a maximum of about 10,000 cd/m². Anything brighter than about 10,000 cd/m² would be uncomfortable to look at, regardless of the ambient brightness level. The desired display luminance range therefore extends from about 1 to about 10,000 cd/m², which is the range for which a display can be easily and comfortably viewed.

FIG. 5B illustrates how reflective displays do not achieve the desired performance range as illustrated in FIG. 5A. In the plot in FIG. 5B, the box labeled “Performance range achieved by conventional reflective displays” outlines the area where reflective displays perform well in the ambient lighting conditions covered in the plot. As the ambient illuminance increases, the display luminance also increases leading to better reflective display performance. In the boxed area labeled “Conventional reflective displays cannot achieve the required performance in this zone”, reflective displays typically do not have sufficient reflectance to maximally reflect the ambient light that is available and thus they cannot achieve the display luminance required in this performance zone.

FIG. 5C illustrates the performance of conventional emissive displays in ambient lighting. The plot in FIG. 5C is the same as in FIG. 5A but describes the performance for a conventional emissive display in low and high ambient lighting. Emissive displays perform better in low ambient lighting conditions. This is shown in the area labeled “Performance range achieved by conventional emissive displays”. In high ambient lighting conditions, such as on a sunny day at the beach, emissive displays tend to be washed out and difficult to view. This is shown in the area of the plot labeled “Conventional emissive displays cannot achieve the required performance in this zone”. An emissive display may be able to combat this limitation to some extent by increasing the intensity or brightness of the display to partly overcome the high ambient lighting level. As a result more battery power must be used and consumed leading to shortened device run time.

Reflective-emissive display embodiments as describe in this application may overcome the deficiencies of reflective displays in low ambient lighting and emissive displays in high ambient lighting conditions. By controlling when a reflective-emissive display is in the reflection mode or emissive mode based on the level of ambient lighting, a broader range of display luminance may be achieved than separate reflective and emissive displays combined. A reflective-emissive display achieves the full desired range of display luminance to achieve images with bright, saturated colors. FIG. 5D illustrates the performance of an embodiment of a reflective-emissive display described herein. The area labeled “Full range of luminance values achievable with hybrid reflective-emissive displays” illustrates the full desired range of display luminance to achieve images with bright, saturated colors.

The following exemplary and non-limiting embodiments provide various implementations of the disclosure.

Example 1 relates to a Totally Internally Reflective (TIR) display, comprising: a transparent front sheet having a top surface and a bottom surface, the bottom surface defined by a plurality of protrusions; a front electrode associated with the transparent front sheet; a rear support to form a cavity between the rear electrode and the transparent front sheet, the cavity configured to receive one or more electrophoretically mobile particles that move responsive to a bias applied to the front electrode and the rear electrode; a plurality of light emitters positioned in the cavity, at least one of the plurality of emitters configured to direct light rays through the cavity toward at least one of the plurality of protrusions.

Example 2 relates to the TIR display of example 1, wherein at least one of the plurality of protrusions defines a hemispherical protrusion.

Example 3 relates to the TIR display of example 1, wherein the rear support further comprises a rear electrode.

Example 4 relates to the TIR display of example 1, wherein the cavity is configured to receive a transparent medium.

Example 5 relates to the TIR display of example 1, wherein the plurality of light emitters are formed over the rear support.

Example 6 relates to the TIR display of example 1, wherein the plurality of light emitters are integrated with the rear support.

Example 7 relates to the TIR display of example 1, further comprising a sensor adapted to detect ambient light to thereby adjust brightness of light emitted from at least one emitter.

Example 8 relates to the TIR display of example 1, further comprising a bias source engageable with one or more of the front or the rear electrodes to form an electromagnetic field in the cavity.

Example 9 relates to the TIR display of example 8, further comprising a processor circuitry and a memory circuitry configured to control the bias source to thereby provide the electromagnetic field in the cavity.

Example 10 relates to the TIR display of example 1, further comprising a dielectric layer covering one or more of the top or rear electrodes.

Example 11 relates to the TIR display of example 1, further comprising an image control system, wherein the image control system is configured to: (1) determine whether a displayed image, on a pixel-by-pixel basis, provides an efficient or optimal display of the image, (2) identify a desired image characteristics of each subpixel, and (3) apply a corrective control signal to at least one of an emissive component control and a reflective component control of each subpixel to achieve a desired accuracy and color saturation in the overall image.

Example 12 relates to a pixel array display, comprising: a transparent front sheet having a top surface and a bottom surface, the bottom surface of the transparent front sheet having a plurality of protrusions, each protrusion defining a pixel in an array of pixels; a rear support to form a cavity between the rear electrode and the transparent front sheet, the cavity configured to receive one or more electrophoretically mobile particles that move responsive to an applied bias; a plurality of light emitters positioned in the cavity, each of the plurality of light emitters corresponding to one of the plurality of protrusions and configured to direct a light ray through the cavity toward a corresponding protrusion.

Example 13 relates to the display of example 12, further comprising a front electrode associated with the transparent front sheet.

Example 14 relates to the display of example 12, wherein at least one of the plurality of light emitters is substantially aligned with the apex of the corresponding protrusion.

Example 15 relates to the display of example 12, wherein each pixel further comprises a color filter.

Example 16 relates to the display of example 15, wherein at least one of the plurality of pixels comprises an emitter that emits a light ray that is substantially the same color as the filter color.

Example 17 relates to the display of example 12, wherein the rear support further comprises a rear electrode.

Example 18 relates to the display of example 12, wherein the rear support further comprises a plurality of rear electrodes corresponding to each of the emitters.

Example 19 relates to the display of example 12, wherein the cavity is configured to receive a transparent medium.

Example 20 relates to the display of example 12, further comprising a sensor adapted to detect ambient light to thereby adjust brightness of light emitted from at least one emitter.

Example 21 relates to the display of example 12, further comprising a sensor adapted to detect ambient light to thereby adjust brightness of light emitted from at least one emitter and the color filter corresponding to the emitter.

Example 22 relates to the display of example 19, further comprising a bias source engageable with one or more of the front or the rear electrodes corresponding to one pixel to thereby form an electromagnetic field therebetween.

Example 23 relates to the display of example 22, further comprising a processor circuitry and a memory circuitry configured to control the bias source.

Example 24 relates to the TIR display of example B, further comprising an image control system configured to (a) analyze the image produced by the display on a pixel-by-pixel basis to ensure that the display simultaneously achieves the most efficient and optimal image; (b) identify the desired image characteristics of each subpixel; and (c) apply the correct control signal to both the emissive component control and the reflective component control of each subpixel to achieve the desired accuracy and saturation of color in the overall image.

Example 25 relates to a Totally Internally Reflective (TIR) display, comprising a transparent front sheet having a top surface and a bottom surface, the bottom surface defined by a plurality of protrusions; a front electrode associated with the transparent front sheet; a rear support to form a cavity between the rear electrode and the transparent front sheet; a plurality of light emitters positioned in the cavity, at least one of the plurality of emitters configured to direct light rays through the cavity toward at least one of the plurality of protrusions.

Example 26 relates to the display of example 25, wherein at least one of the plurality of protrusions defines a hemispherical protrusion.

Example 27 relates to the display of example 25, wherein the rear support further comprises a rear electrode.

Example 28 relates to the display of example 25, wherein the cavity is configured to receive a transparent medium.

Example 29 relates to the display of example 25, wherein the plurality of light emitters are formed over the rear support.

Example 30 relates to the display of example 25, wherein the plurality of light emitters are integrated with the rear support.

Example 31 relates to the display of example 25, further comprising a sensor adapted to detect ambient light to thereby adjust brightness of light emitted from at least one emitter.

Example 32 relates to the display of example 25, further comprising a bias source engageable with one or more of the front or the rear electrodes to form an electromagnetic field in the cavity, the bias source configured to move one or more electrophilically mobile particles in the cavity to affect a TIR within the display.

Example 33 relates to the display of example 32, further comprising a processor circuitry and a memory circuitry configured to control the bias source to thereby provide the electromagnetic field in the cavity and to move the electrophoretically mobile particles.

Example 34 relates to the TIR display of example 25, further comprising an image control system configured to (a) analyze the image produced by the display on a pixel-by-pixel basis to ensure that the display simultaneously achieves the most efficient and optimal image; (b) identify the desired image characteristics of each subpixel; and (c) apply the correct control signal to both the emissive component control and the reflective component control of each subpixel to achieve the desired accuracy and saturation of color in the overall image.

Example 35 relates to a method for switching a Totally Internally Reflective (TIR) image display from a first state to a second state, comprising: receiving a plurality of electrophoretically mobile particles at a gap formed between front plane and a back plane of the display, the front plane further comprising a front electrode and the back plane further comprising a back electrode; moving the plurality of light absorbing particles toward the front electrode by supplying a first bias to one or more of the front or the back electrodes, the light absorbing particles substantially absorbing the incoming light rays proximal to the front electrode; moving the plurality of light absorbing particles toward the back electrode by supplying a second bias to one or more of the front or the back electrodes, the light absorbing particles accumulating at or proximal to the back electrode to thereby cause a substantial totally internal reflection of an incoming ray; and generating an internal light ray from the back plane to the front plane.

Example 36 relates to the method of example 35, wherein the back electrode defines a plurality of back electrodes.

Example 37 relates to the method of example 35, wherein the step of generating the internal ray further comprises illuminating a light emitter.

Example 38 relates to the method of example 35, further comprising generating an internal ray in response to an ambient light level.

Example 39 relates to the method of example 35, wherein the first bias and the second bias are substantially opposite each other.

Example 40 relates to the method of example 35, further comprising an image control system configured to (a) analyze the image produced by the display on a pixel-by-pixel basis to ensure that the display simultaneously achieves the most efficient and optimal image; (b) identify the desired image characteristics of each subpixel; and (c) apply the correct control signal to both the emissive component control and the reflective component control of each subpixel to achieve the desired accuracy and saturation of color in the overall image.

Example 41 relates to an image control system which may: (a) analyze the image produced by the display on a pixel-by-pixel basis to ensure that the display simultaneously achieves the most efficient and optimal image; (b) may identify the desired image characteristics of each subpixel; and (c) may apply the correct control signal to both the emissive component control and the reflective component control of each subpixel to achieve the desired accuracy and saturation of color in the overall image.

What is claimed is:

1. A Totally Internally Reflective (TIR) display, comprising:
a transparent front sheet having a top surface and a bottom surface, the bottom surface defined by a plurality of protrusions;
a front electrode associated with the transparent front sheet;
a rear support to form a cavity between the rear electrode and the transparent front sheet, the cavity configured to receive one or more electrophoretically mobile particles that move responsive to a bias applied to the front electrode and the rear electrode;
a plurality of light emitters positioned in the cavity, at least one of the plurality of emitters configured to direct light rays through the cavity toward at least one of the plurality of protrusions.

2. The TIR display of claim 1, wherein at least one of the plurality of protrusions defines a hemispherical protrusion.

3. The TIR display of claim 1, wherein the rear support further comprises a rear electrode.

4. The TIR display of claim 1, wherein the cavity is configured to receive a transparent medium.

5. The TIR display of claim 1, wherein the plurality of light emitters are formed over the rear support.

6. The TIR display of claim 1, wherein the plurality of light emitters are integrated with the rear support.

7. The TIR display of claim 1, further comprising a sensor adapted to detect ambient light to thereby adjust brightness of light emitted from at least one emitter.

8. The TIR display of claim 1, further comprising a bias source engageable with one or more of the front or the rear electrodes to form an electromagnetic field in the cavity.

9. The TIR display of claim 8, further comprising a processor circuitry and a memory circuitry configured to control the bias source to thereby provide the electromagnetic field in the cavity.

10. The TIR display of claim 1, further comprising a dielectric layer covering one or more of the top or rear electrodes.

11. The TIR display of claim 1, further comprising an image control system, wherein the image control system is configured to: (1) determine whether a displayed image, on a pixel-by-pixel basis, provides an efficient or optimal display of the image, (2) identify a desired image characteristics of each subpixel, and (3) apply a corrective control signal to at least one of an emissive component control and a reflective component control of each subpixel to achieve a desired accuracy and color saturation in the overall image.

12. A pixel array display, comprising:
a transparent front sheet having a top surface and a bottom surface, the bottom surface of the transparent front sheet having a plurality of protrusions, each protrusion defining a pixel in an array of pixels;
a rear support to form a cavity between the rear electrode and the transparent front sheet, the cavity configured to receive one or more electrophoretically mobile particles that move responsive to an applied bias;
a plurality of light emitters positioned in the cavity, each of the plurality of light emitters corresponding to one of the plurality of protrusions and configured to direct a light ray through the cavity toward a corresponding protrusion.

13. The display of claim 12, further comprising a front electrode associated with the transparent front sheet.

14. The display of claim 12, wherein at least one of the plurality of light emitters is substantially aligned with the apex of the corresponding protrusion.

15. The display of claim 12, wherein each pixel further comprises a color filter.

16. The display of claim 15, wherein at least one of the plurality of pixels comprises an emitter that emits a light ray that is substantially the same color as the filter color.

17. The display of claim 12, wherein the rear support further comprises a rear electrode.

18. The display of claim 12, wherein the rear support further comprises a plurality of rear electrodes corresponding to each of the emitters.

19. The display of claim 12, wherein the cavity is configured to receive a transparent medium.

20. The display of claim 12, further comprising a sensor adapted to detect ambient light to thereby adjust brightness of light emitted from at least one emitter.

21. The display of claim 12, further comprising a sensor adapted to detect ambient light to thereby adjust brightness of light emitted from at least one emitter and the color filter corresponding to the emitter.

22. The display of claim 19, further comprising a bias source engageable with one or more of the front or the rear electrodes corresponding to one pixel to thereby form an electromagnetic field therebetween.

23. The display of claim 22, further comprising a processor circuitry and a memory circuitry configured to control the bias source.

24. The TIR display of claim B, further comprising an image control system configured to (a) analyze the image produced by the display on a pixel-by-pixel basis to ensure that the display simultaneously achieves the most efficient and optimal image; (b) identify the desired image characteristics of each subpixel; and (c) apply the correct control signal to both the emissive component control and the reflective component control of each subpixel to achieve the desired accuracy and saturation of color in the overall image.

25. A Totally Internally Reflective (TIR) display, comprising:
a transparent front sheet having a top surface and a bottom surface, the bottom surface defined by a plurality of protrusions;
a front electrode associated with the transparent front sheet;
a rear support to form a cavity between the rear electrode and the transparent front sheet;
a plurality of light emitters positioned in the cavity, at least one of the plurality of emitters configured to direct light rays through the cavity toward at least one of the plurality of protrusions.

26. The display of claim 25, wherein at least one of the plurality of protrusions defines a hemispherical protrusion.

27. The display of claim 25, wherein the rear support further comprises a rear electrode.

28. The display of claim 25, wherein the cavity is configured to receive a transparent medium.

29. The display of claim 25, wherein the plurality of light emitters are formed over the rear support.

30. The display of claim 25, wherein the plurality of light emitters are integrated with the rear support.

31. The display of claim 25, further comprising a sensor adapted to detect ambient light to thereby adjust brightness of light emitted from at least one emitter.

32. The display of claim 25, further comprising a bias source engageable with one or more of the front or the rear electrodes to form an electromagnetic field in the cavity, the bias source configured to move one or more electrophilically mobile particles in the cavity to affect a TIR within the display.

33. The display of claim 32, further comprising a processor circuitry and a memory circuitry configured to control the bias source to thereby provide the electromagnetic field in the cavity and to move the electrophoretically mobile particles.

34. The TIR display of claim 25, further comprising an image control system configured to (a) analyze the image produced by the display on a pixel-by-pixel basis to ensure that the display simultaneously achieves the most efficient and optimal image; (b) identify the desired image characteristics of each subpixel; and (c) apply the correct control signal to both the emissive component control and the reflective component control of each subpixel to achieve the desired accuracy and saturation of color in the overall image.

35. A method for switching a Totally Internally Reflective (TIR) image display from a first state to a second state, comprising:
receiving a plurality of electrophoretically mobile particles at a gap formed between front plane and a back plane of the display, the front plane further comprising a front electrode and the back plane further comprising a back electrode;
moving the plurality of light absorbing particles toward the front electrode by supplying a first bias to one or more of the front or the back electrodes, the light absorbing particles substantially absorbing the incoming light rays proximal to the front electrode;
moving the plurality of light absorbing particles toward the back electrode by supplying a second bias to one or more of the front or the back electrodes, the light absorbing particles accumulating at or proximal to the back electrode to thereby cause a substantial totally internal reflection of an incoming ray; and
generating an internal light ray from the back plane to the front plane.

36. The method of claim 35, wherein the back electrode defines a plurality of back electrodes.

37. The method of claim 35, wherein the step of generating the internal ray further comprises illuminating a light emitter.

38. The method of claim 35, further comprising generating an internal ray in response to an ambient light level.

39. The method of claim 35, wherein the first bias and the second bias are substantially opposite each other.

40. The method of claim 35, further comprising an image control system configured to (a) analyze the image produced by the display on a pixel-by-pixel basis to ensure that the display simultaneously achieves the most efficient and optimal image; (b) identify the desired image characteristics of each subpixel; and (c) apply the correct control signal to both the emissive component control and the reflective component control of each subpixel to achieve the desired accuracy and saturation of color in the overall image.
